(19) United States
(12) Patent Application Publication
(10) Pub. No.: US 2008/0205286 A1
(43) Pub. Date: Aug. 28, 2008

(54) Test system using local loop to establish connection to baseboard management control and method therefor

(75) Inventors: Gui-He Li, Tianjin (CN); Tom Chen, Taipei (TW); Win-Harn Liu, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/710,495

(22) Filed: Feb. 26, 2007

(51) Int. Cl. H04L 1/14

(52) U.S. Cl. 370/249

(57) ABSTRACT

A test system using a local loop to establish connection to baseboard management control is provided. The test system includes more than one host terminals having at least one network interface card (NIC) and at least one baseboard management controller (BMC) having one NIC. After establishing a connection for test between the host terminals and a remote subscriber, a connection for loop test is established with the BMC through a virtual address, so as to deliver a test instruction to the BMC for testing and to loop back a test result. The test system establishes the connection for loop test through the virtual address so as to perform a remote platform test similar to an inner loop test. Therefore, the test result will not be influenced by a network environment setting, and thus a batch test can be adopted to save the test time.

### BACKGROUND OF THE INVENTION

1. Field of Invention

The present invention relates to a test system. More particularly, the present invention relates to a test system using a local loop to establish connection to baseboard management control, so as to perform a batch test on at least one host and a method therefor.

2. Related Art

Intelligent platform management interface (IPMI) is an integrated remote hardware management standard developed by the industry, which defines a universal platform inspection interface, for increasing the interoperability between the mainboard and the computer host, the mainboard and the server management software, and even between the servers. The definition and the scope covered by the IPMI include layers, such as software, firmware, and hardware. In brief, the main object of the IPMI is to provide a layered management architecture for providing management directed to the integration of each layer based on a modularization design. The layered management architecture includes elements, such as software, hardware, and firmware-slave processor, chipset, BIOS, and mainboard, which all belong to the management scope of the IPMI. The IPMI firstly performs programming on the sensing and monitoring system in the device and equipment. Practically, the IPMI uses a baseboard management controller (BMC) as a monitoring system, the BMC may be a sub card (or an adapter card) on the mainboard used to manage various tasks of the monitoring system in the host, for example, monitoring whether the system is in a normal operation, and making the system record file.

Recently, in the industry, the BMC is widely used in the outgoing test on computers or electronic devices. The method is that the BMC is installed in a computer to be tested (hereinafter referred to as a host) and is connected to a subnet, and network addresses of the network interface card (NIC) of the BMC and the host are set. After the network address is set, the client may be connected to the BMC and the host through the subnet by means of, for example, remote access, so as to establish a connection between the BMC and the host and to enable the host to configure the BMC. FIG. 1 is a schematic view of connecting the host and the BMC through the subnet. Referring to FIG. 1, firstly a physical address 10.10.0.2 and a physical address 10.10.0.1 are respectively allocated to an NIC 112 of a host 110 and an NIC 122 on a BMC 120 in the host, and the NICs are connected to a subnet. The same steps are performed on another host 130 and a BMC 140 therein, the respective NICs (132 and 142) are set as 10.10.0.4 and 10.10.0.3, and the NICs are connected to the subnet. Next, the remote client 150 activates the host 110 through the address 10.10.0.2 to set parameters of the BMC, and enables the host to be connected with the BMC through the address 10.10.0.1. Similarly, the host 130 also adopts similar steps to finish setting and establish the connection for performing the test on the host. The above kind of the method often costs a great amount of time on the construction and configuration of the local area network, and when the local area network is constructed, the address configuration of each host may affect the test result. For example, when a hundred hosts are tested simultaneously, if the address settings of two hosts are identical and thus it is impossible to use the network function of the host, the test result looped back may indicate that the two hosts are defective. In addition, as the address quantity of the subnet is limited, for example, the subnet section at the same level C can only test 128 hosts simultaneously at the most, and it is impossible to perform the batch-test on a large number of hosts.

### SUMMARY OF THE INVENTION

In view of the above problems, the present invention is directed to provide a test system using a local loop to establish a connection to baseboard management control. The connection for loop test is established through a virtual address for testing, such that when a plurality of test machines performs test in the same subnet, the limitation caused by the IP quantity may not increase the batch test times and prolong the test time.

In order to achieve the above objects, the present invention can be realized from system and method. The system provided by the present invention includes at least one host terminal, having at least one NIC, for establishing a connection for test with a remote subscriber, and establishing a connection to baseboard management control through the host terminal; and at least one BMC, having an NIC, for establishing a connection for loop test with the host terminal, so as to test the host terminal. After a connection for test is established by the remote subscriber, the host terminal and the BMC set corresponding virtual addresses, the host terminal and the BMC establish a connection for loop test through the virtual addresses, and the host terminal delivers at least one test instruction to the BMC for testing and loops back a test result during the test.

In the test system according to an embodiment of the present invention, the NIC of the host terminal has at least one physical address or virtual address. Similarly, the BMC also has a physical address or a virtual address. The virtual address is one address in an address section (192.1680.0 to 192.168.255.255) of the private IP. After the host terminal and the BMC establish a connection for loop test through the virtual address, the host terminal sends a test instruction (for example, an IPMI instruction) to perform a test. The functions of the test include obtaining a client/password of the BMC, getting a device ID, performing a data write test, performing a data read test, or delivering/receiving a test data.

In the test system according to an embodiment of the present invention, the test result includes the following error types: error of the NIC of the mainboard, error of the NIC of the BMC, failure of the remote access function of the NIC of the BMC, and the failure that the BMC supports the remote access function but not support the IPMI instruction corresponding to the remote access function.

The method of the present invention includes: firstly, reading and storing a preset first physical address of a host terminal; next, setting a first virtual address of the host terminal; then, reading and storing a preset second physical address of a BMC; then, setting a second virtual address of the BMC; afterward, establishing a connection with the BMC for loop test through the first virtual address of the host terminal and the second virtual address of the BMC by the host terminal; and finally, delivering at least one test instruction for testing and looping back a test result during the test by the host terminal, after the host terminal and the BMC successively establish the connection for loop test.

The test method according to an embodiment of the present invention includes: when the host terminal fails to read/store the first physical address, a read error message of the NIC of the host terminal is looped back; when the host terminal fails to set the first virtual address, a set address error message of the NIC of the host terminal is looped back; when the BMC fails to read/store the second physical address, a read error message of the NIC of the BMC is looped back; and when the BMC fails to set the first virtual address, a set address error message of the NIC of the BMC is looped back.

In the present invention, the host terminal and the BMC establish a connection for loop test through the virtual address, and, for example, the IPMI instruction is used to perform a test similar to the inner loop test. Compared with the conventional art, when the present invention performs the batch test, the test result may not be affected by the network environment setting, (for example, in the same subnet, if two different hosts are set as the same physical address to perform the test, the problem of the repeated network address will occur, which may be determined by mistake that the host NICs fail) and each host may individually form a local area network without mutual interference with the corresponding BMC for performing the batch test, such that the test time is saved.

The detailed features and practice of the present invention will be described in detail in the following embodiments with reference to the drawings. Those skilled in the arts can easily understand and implement the content of the present invention. Furthermore, the relative objectives and advantages of the present invention are apparent to those skilled in the arts with reference to the content disclosed in the specification and drawings.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1 is a schematic view of using a BMC to perform test on a host terminal according to the conventional art;

FIG. 2 is a schematic view of a test system using a local loop to establish connection to baseboard management control according to an embodiment of the present invention;

FIG. 3 is a flow chart of a test method using a local loop to establish connection to baseboard management control according to an embodiment of the present invention.

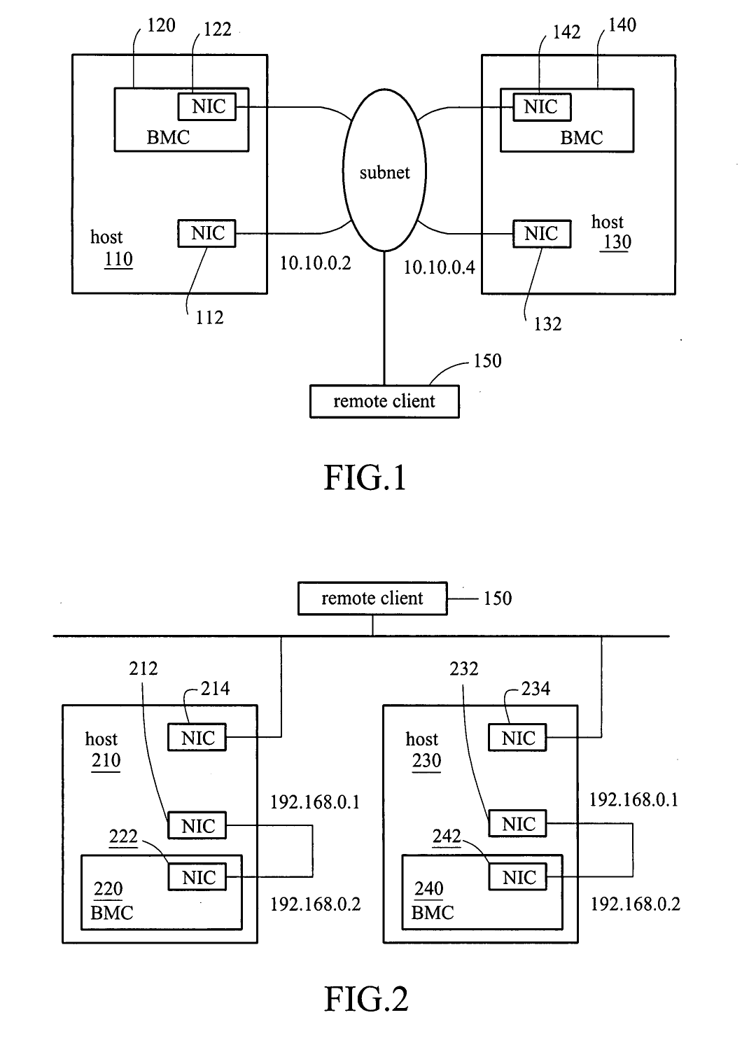

### DETAILED DESCRIPTION OF THE INVENTION

In order to make the aforementioned and other objectives, features, and advantages of the present invention comprehensible, preferred embodiments accompanied with figures are described in detail below.

FIG. 2 is a schematic view of a test system using a local loop to establish connection to baseboard management control according to an embodiment of the present invention. Referring to FIG. 2, the test system of this embodiment establishes a connection to baseboard management control through a local loop, such that the host terminal and the BMC form an independent local area network, and the BMC is used to control and inspect the host terminal. In this embodiment, the test system includes at least one host terminal (host terminals 210 and 230 in this embodiment), and a BMC (220 and 240) respectively inserted in each of the host terminals, for performing outgoing tests on the functions of the host terminals. The host terminal (210 or 230) respectively has NICs (212, 214) and NICs (232, 234), the NICs 212 and 232 are used to establish a connection to the BMC with the NICs (222, 242) of the BMCs 220, 240, and outgoing tests of functions can be performed on the host terminals 210, 230 by the BMCs 220 and 240 through the connection. Another NICs 214, 234 of the host terminals 210, 230 are used to form a connection for test with the remote client 150, respectively, and the remote client is informed of the test results through the connections for test.

The so-called connection to BMC is a connection established and connected to a BMC for testing a host. In this embodiment, the connection between the host terminals (210 and 230) and the respectively corresponding BMCs (220 and 240) is a connection for loop test. In brief, a connection is established between the BMCs (220 and 240) and the host terminals (210 and 230), respectively, so as to perform a test in a manner similar to the loop test. After a connection for test is established between the remote client 150 and the NIC 214 of the host terminal 210 (the NIC 234 of the host terminal 230), a corresponding virtual address is set first by the host terminals (210, 230) and the corresponding BMCs (220, 240), respectively, for example, set as one network address in an address section of 192.168.0.0 to 192.168.255.255 of the private IP, and after the test is finished, the virtual addresses are used to establish a connection for loop test. The host terminal (210 or 230) delivers some test data or some test instructions to the corresponding BMC (220 or 240) through the connection for loop test for testing, and loops back some test results during the test. In this embodiment, for example, an IPMI instruction is used to obtain a client/password, get a device ID, perform a data write test, perform a data read test, or deliver/receive a test data. The types of error looped back after the test, for example, include error of the NIC of the mainboard, error of the NIC of the BMC, failure of the remote access function of the NIC of the BMC, and the failure that the BMC supports the remote access function but not support the IPMI instruction corresponding to the remote access function.

It should be noted that in this embodiment, a connection for loop test is established between each host terminal and the corresponding BMC (220 or 240) through a virtual address. The connection for loop test can be seen as performing the test in the host, as each pair of host terminal and BMC can be considered as an independent local area network, so the same virtual address can be used repeatedly. Again referring to FIG. 2, it is found in the figure that the connection between the NIC 212 of the host terminal 210 and the NIC 222 of the BMC 220 is realized by connecting the address 192.168.0.1 to 192.168.0.8, which is the same as the connection established between the NIC 232 of another host terminal 230 and the NIC 242 of the BMC 240. As the connections established between the host terminals 210, 230 and the NICs of the corresponding BMCs can be considered as connections of subnets in different sections, even if the same virtual network address is adopted, the network address overlapping may not occur to affect the test result. In the following paragraphs, the implementing process of an embodiment of the present invention is illustrated.

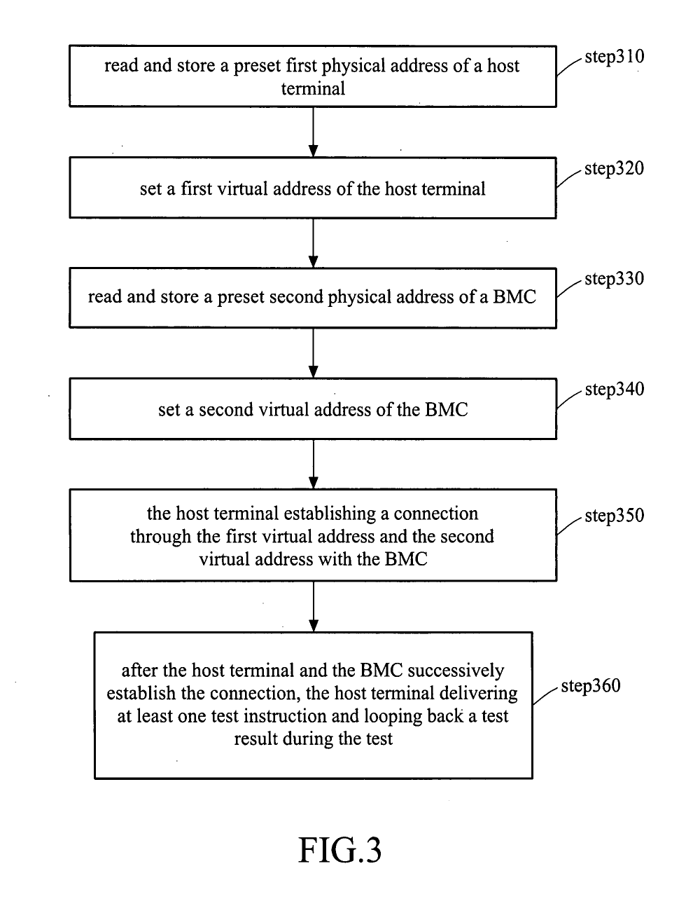

FIG. 3 is a flow chart of a test method using the local loop to establish connection to baseboard management control according to an embodiment of the present invention. Referring to FIGS. 2 and 3, the test method of this embodiment is suitable for testing at least one host terminal, and includes the following steps. Firstly, a preset first physical address of a host terminal is read and stored (Step 310). Next, a first virtual address of the host terminal is set (Step 320), the network address is classified into public IP and private IP, and the private IP also includes the address kept for the host to perform self-test. The virtual address of this embodiment is an address in the private IP section of 192.168.0.0 to 192.168.255.255. Then, a preset second physical address of a BMC is read and stored (Step 330). Afterward, a second virtual address of the BMC is set (Step 340). Like the above definition of the virtual address, the BMC (220 or 240) selects an address that is not identical to the first virtual address from the address section of 192.168.0.0 to 192.168.255.255. Then, the host terminal establishes a connection with the BMC for loop test through the first virtual address of the host terminal and the second virtual address of the BMC (Step 350). Finally, after the host terminal and the BMC successively establish the connection for loop test, the host terminal delivers at least one test instruction for testing and loops back a test result obtained during the test (Step 360).

Following the above paragraph, the test instruction of the host terminal (210 or 230) is, for example, an IPMI instruction with the following functions such as obtaining a client/password of the BMC, getting a device ID, performing a data write test, performing a data read test, or delivering/receiving a test data. After the test, the host terminal (210 or 230) loops back the test result to the remote client, and the types of error looped back are, for example, error of the NIC of the mainboard, error of the NIC of the BMC, failure of the remote access function of the NIC of the BMC, and the failure that the BMC supports the remote access function but not support the IPMI instruction corresponding to the remote access function.

In the above test process, when the host terminal fails to read/store the first physical address, a read error message of the NIC of the host terminal is looped back. When the host terminal fails to set the first virtual address, a set address error message of the NIC of the host terminal is looped back. When the BMC fails to read/store the second physical address, a read error message of the NIC of the BMC is looped back. When the BMC fails to set the first virtual address, a set address error message of the NIC of the BMC is looped back. After the test is finished, the address of the host terminal and the address of the corresponding BMC will be set as the original physical address (the first physical address or the second physical address).

By the way, in this embodiment of the present invention, a host terminal includes two NICs, and one of the NICs is set as the virtual address to establish a connection for loop test with the NIC of the BMC, and the other NIC is used to establish a connection with the remote client and to loop back the test data. If the host terminal only has one NIC, the above method can also be used to form a test line of inner loop for a single board test without being connected to other subnets. In addition, in some operating environments, for example, LINUX operating system, the same NIC may simultaneously use a plurality of network addresses and a plurality of connection interfaces. At this point, it is also applicable that one NIC establishes a connection through the physical address, and the other NIC establishes a connection through the virtual address according to the above embodiment, which will not be described in detail herein again. In brief, it falls in the scope of the present invention that the host terminal uses the NIC of any multi-network interface to establish the connection for loop test with the NIC of the BMC.

To sum up, in the present invention, a plurality of hosts adopts the virtual address to respectively form local area networks without mutual interference with a plurality of BMCs, and a connection for loop test is established, so as to test machine in a manner similar to the inner loop test. Therefore, compared with the conventional art, the present invention has the following advantages.

(1) When a plurality of host terminals of the same subnet simultaneously and respectively undergoes the test with the corresponding BMCs, the problem of the repeated network address will not occur to affect the test result.

(2) the hosts and the corresponding BMCs may form local area networks without mutual interference for performing the batch test, so as to save the test time of the machine.

(3) The problem of the exhaustion of physical address resources is avoided in the same subnet.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A test system using a local loop to establish connection to baseboard management control, suitable for testing at least one host terminal, comprising:
at least one host terminal, having at least one network interface card (NIC), for establishing a connection for test with a remote subscriber, and establishing connection to the baseboard management control through the host terminal; and
at least one baseboard management controller (BMC), having an NIC, for establishing a connection for loop test with the host terminal, so as to test the host terminal;
wherein, after the connection for test is established, the host terminal and the BMC set corresponding virtual addresses, and the connection for loop test is established through the virtual addresses; the host terminal delivers at least one test instruction to the BMC for testing and loops back a test result during the test.

2. The test system as claimed in claim 1, wherein the NIC of the host terminal has at least one address comprising a physical address and a virtual address.

3. The test system as claimed in claim 1, wherein the virtual address is one address in an address section (192.168.0.0 to 192.168.255.255) of a private IP.

4. The test system as claimed in claim 1, wherein the test instruction is an intelligent platform management interface (IPMI) instruction.

5. The test system as claimed in claim 4, wherein functions of the IPMI instruction further comprise obtaining a client/password of the BMC, getting a device ID, performing a data write test, performing a data read test, or delivering/receiving a test data.

6. The test system as claimed in claim 1, wherein the test result comprises the following error types: error of the NIC of mainboard, error of the NIC of the BMC, failure of remote access function of the NIC of the BMC, and failure that the BMC supports remote access function but not support the IPMI instruction corresponding to the remote access function.

7. The test system as claimed in claim 1, wherein the connection for loop test is a connection for inner loop test with two ends in a same host.

8. A test method using a local loop to establish connection to baseboard management control, suitable for testing at least one host terminal, comprising:
reading and storing a preset first physical address of a host terminal;
setting a first virtual address of the host terminal;
reading and storing a preset second physical address of a baseboard management controller (BMC);
setting a second virtual address of the BMC;
establishing a connection for loop test through the first virtual address of the host terminal and the second virtual address of the BMC by the host terminal; and
delivering at least one test instruction for testing and looping back a test result during the test by the host terminal, after the host terminal and the BMC successively establish the connection for loop test.

9. The test method as claimed in claim 8, wherein the first physical address and the second physical address are one address in a public IP.

10. The test method as claimed in claim 8, wherein the first virtual address and the second virtual address are one address in an address section (192.168.0.0 to 192.168.255.255) of a private IP.

11. The test method as claimed in claim 8, wherein when the host terminal fails to read/store the first physical address, a read error message of the NIC of the host terminal is looped back.

12. The test method as claimed in claim 8, wherein when the host terminal fails to set the first virtual address, a set address error message of the NIC of the host terminal is looped back.

13. The test method as claimed in claim 8, wherein when the BMC fails to read/store the second physical address, a read error message of the NIC of the BMC is looped back.

14. The test method as claimed in claim 8, wherein when the BMC fails to set the first virtual address, a set address error message of the NIC of the BMC is looped back.

15. The test method as claimed in claim 8, wherein the test instruction is an intelligent platform management interface (IPMI) instruction.

16. The test method as claimed in claim 15, wherein functions of the IPMI instruction further comprise obtaining a client/password of the BMC, getting a device ID, performing a data write test, performing a data read test, or delivering/receiving a test data.

17. The test method as claimed in claim 8, wherein the test result comprises the following error types: error of the NIC of mainboard, error of the NIC of the BMC, failure of remote access function of the NIC of the BMC, and failure that the BMC supports remote access function but not support the IPMI instruction corresponding to the remote access function.

18. The test method as claimed in claim 8, wherein after the host terminal receives the test result, an address of the host terminal is set as the first physical address, and an address of the BMC is set as the second physical address.

19. The test method as claimed in claim 8, wherein the connection for loop test is a connection for inner loop test with two ends in a same host.
